(19) United States
(12) Patent Application Publication
(10) Pub. No.: US 2008/0027916 A1
(43) Pub. Date: Jan. 31, 2008

(54) Computer program, method, and apparatus for detecting duplicate data

(75) Inventors: Tatsuya Asai, Kawasaki (JP); Seishi Okamoto, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 11/599,534

(22) Filed: Nov. 14, 2006

(30) Foreign Application Priority Data
Jul. 31, 2006 (JP) 2006-207904

(51) Int. Cl. G06F 17/30

(52) U.S. Cl. 707/3

(57) ABSTRACT

A computer program, method, and apparatus for narrowing data down to detect duplicate data in a short time. A computer functions as a syntax tree constructor for creating a syntax tree by extracting a plurality of letters existing at prescribed discrete positions from the character string of each of the data and a duplicate data detector for detecting some data as possible duplicate data if the data have reached a same leaf node of the syntax tree.

### CROSS-REFERENCE TO RELATED APPLICATIONS

This application is based upon and claims the benefits of priority from the prior Japanese Patent Application No. 2006-207904, filed on Jul. 31, 2006, the entire contents of which are incorporated herein by reference.

### BACKGROUND OF THE INVENTION

(1) Field of the Invention

This invention relates to a computer program, method, and apparatus for detecting duplicate data, and more particularly, to a computer program, method, and apparatus, which are capable of detecting duplicate data from a plurality of data each having a character string.

(2) Description of the Related Art

In business, database systems are often used to manage various data. Since many users add, update and delete data, identical data with different titles may be created in a database. Registration of such duplicate data wastefully consumes capacity of the database, which results in requiring another operation server in the database system, increasing maintenance cost, and requiring longer time for search.

To avoid these problems, there has been proposed a method of extracting character strings existing at a given part from text data (for example, refer to Japanese Unexamined Patent Publication No. 2004-164120) and detecting duplicate character strings (for example, refer to Japanese Unexamined Patent Publication No. 2004-164133).

In addition, there have been known methods for detecting duplicate character strings by using natural language processing that processes human natural language on a computer or by using machine learning where a computer predicts future data based on past data.

Such methods, however, have drawbacks in that long processing time and very complicated processes are required for detecting duplicate character strings from relatively large data such as Gigabyte data or Terabyte data.

### SUMMARY OF THE INVENTION

This invention has been made in view of foregoing and intends to provide a computer program, method, and apparatus for narrowing data down to detect duplicate data in a short time.

To accomplish the above object, there is provided a computer-readable recording medium containing a duplicate data detection program for detecting duplicate data from a plurality of data each having a character string. This contained duplicate data detection program causes a computer to perform as: a syntax tree constructor for creating a syntax tree by extracting a plurality of letters existing at prescribed discrete positions from the character string of each data; and a duplicate data detector for searching each leaf node of the syntax tree to find some data that have reached the leaf node, and detecting the some data as possible duplicate data.

Further, to accomplish the above object, there is provided a method for detecting duplicate data out of a plurality of data each having a character string. This duplicate data detection method comprises the steps of: creating a syntax tree by extracting a plurality of letters existing at prescribed discrete positions from the character string of each of the plurality of data; searching each leaf node of the syntax tree to find some data that have reached the leaf node of the syntax tree; and detecting the some data as possible duplicate data.

Still further, to accomplish the above object, there is provided an apparatus for detecting duplicate data out of a plurality of data each having a character string. This duplicate data detection apparatus comprises: a syntax tree constructor for creating a syntax tree by extracting a plurality of letters existing at prescribed discrete positions from the character string of each of the plurality of data; and a duplicate data detector for searching each leaf node of the syntax tree to find some data that have reached the leaf node of the syntax tree and detecting the some data as possible duplicate data.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 shows the outline of the present invention.

FIG. 2 shows a hardware configuration of a computer.

FIG. 3 is a functional block diagram of the computer.

FIG. 4 shows an example of a syntax tree.

FIG. 5 is a flowchart of an analysis operation.

FIG. 6 is a flowchart of a first tree construction operation.

FIG. 7 is a flowchart of a second tree construction operation.

FIGS. 8 to 10 show a specific example of the first tree construction operation.

FIG. 11 shows a specific example of the second tree construction operation.

### DESCRIPTION OF THE PREFERRED EMBODIMENTS

Preferred embodiments of this invention will be described in detail with reference to the accompanying drawings. The invention will be first outlined and then the embodiments will be described.

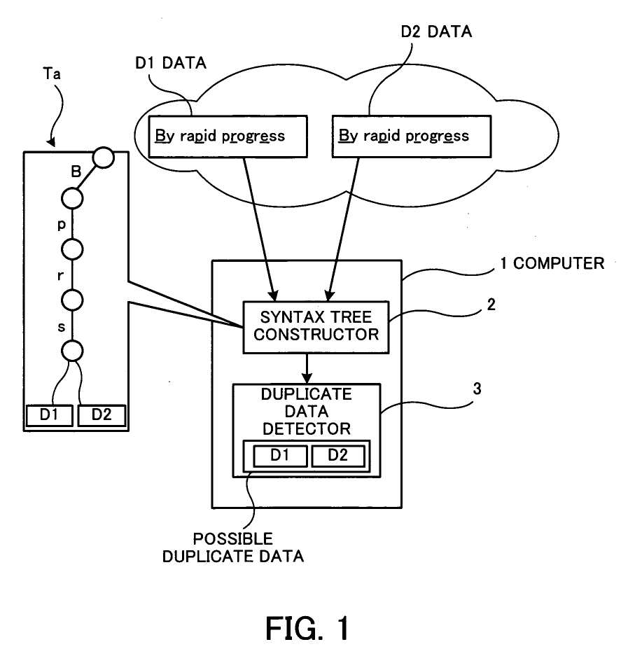

FIG. 1 shows the outline of the invention. A computer 1 of FIG. 1 has a syntax tree constructor 2 and a duplicate data detector 3.

The syntax tree constructor 2 creates a syntax tree by extracting a plurality of letters existing at prescribed discrete positions from every data.

Referring to FIG. 1, a syntax tree Ta is created by extracting four letters, one every four letters, in order from the first letter, with respect to the character string of each data D1, D2.

The duplicate data detector 3 searches each leaf node of the syntax tree Ta to find some data that have reached the leaf node, and detects found data as possible duplicate data. Referring to FIG. 1, the data D1 and D2 are identified as possible duplicate data.

With such a duplicate data detection program, the syntax tree constructor 2 creates a syntax tree by extracting a plurality of letters existing at prescribed discrete positions from data. The duplicate data detector 3 detects data as possible duplicate data if the data have reached a same leaf node of the syntax tree.

An embodiment of this invention will be described.

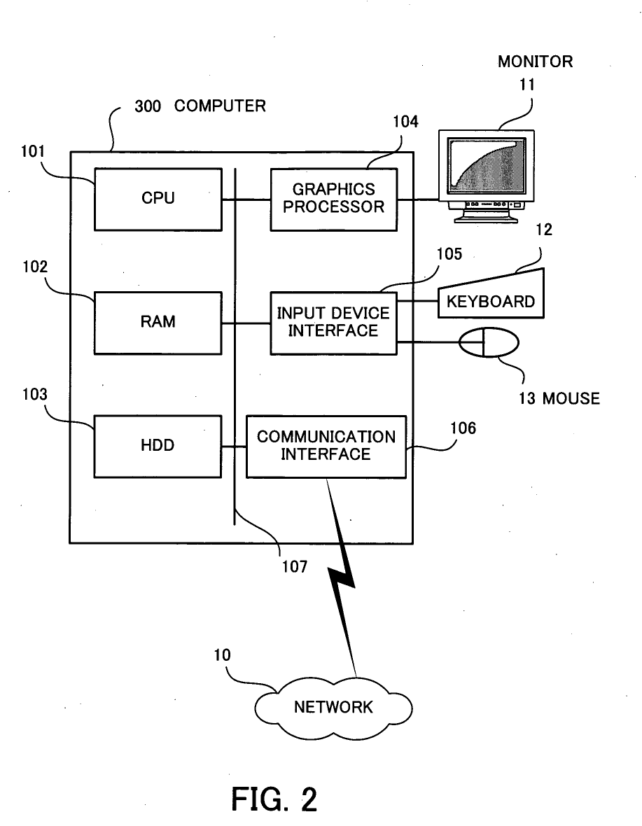

FIG. 2 shows an example hardware configuration of a computer.

The computer 300 is entirely controlled by a Central Processing Unit (CPU) 101. Connected to the CPU 101 via a bus 107 are a Random Access Memory (RAM) 102, a Hard Disk Drive (HDD) 103, a graphics processor 104, an input device interface 105, and a communication interface 106.

The RAM 102 temporarily stores at least part of an Operating System (OS) program and application programs to be executed by the CPU 101. The RAM 102 also stores various kinds of data for CPU processing. The HDD 103 stores program files as well as the OS and the application programs.

The graphics processor 104 is connected to a monitor 11 to display images on the monitor 11 under the control of the CPU 101. The input device interface 105 is connected to a keyboard 12 and a mouse 13 and is designed to transfer signals from the keyboard 12 and the mouse 13 to the CPU 101 via the bus 107.

The communication interface 106 is connected to a network 10 to enable communication with other computers via the network 10.

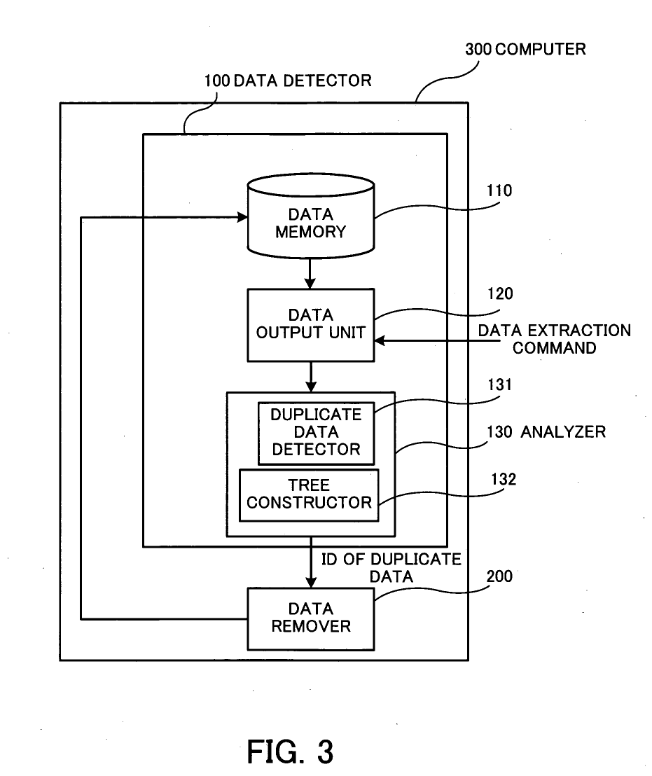

With such a hardware configuration, the processing functions of the embodiment will be implemented. To detect duplicate data, the computer 300 is provided with functions as shown in FIG. 3.

The computer 300 has a data detector (duplicate data detection apparatus) 100 and a data remover 200.

The data detector 100 has a data memory 110, a data output unit 120, and an analyzer 130.

The data memory 110 stores a plurality of document data to be checked.

The data output unit 120 extracts specified document data (hereinafter, referred to as a document data group) from the data memory 110 in response to a data extraction command specifying the document data to be checked. In this connection, this data extraction command is made by a user with the keyboard 12 and/or the mouse 13. Then, the data output unit 120 gives an identifier (ID) to each of the extracted document data and outputs the document data group to the analyzer 130.

The analyzer 130 has a duplicate data detector 131 and a tree constructor 132.

When receiving the document data group, the duplicate data detector 131 provides tree construction parameters to the tree constructor 132 which then creates a syntax tree of the document data group under the tree construction parameters. The tree construction parameters will be described later.

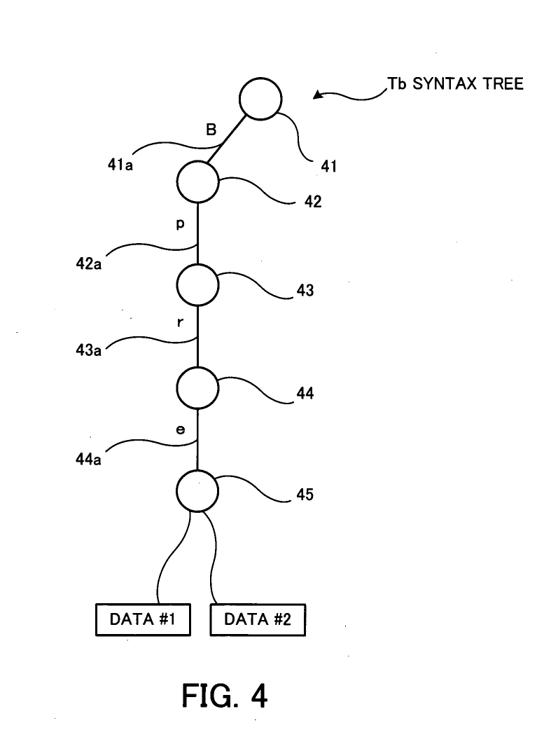

FIG. 4 shows an example of a syntax tree.

A syntax tree Th has nodes 41 to 45 and edges 41a, 42a, 43a, and 44a connecting the nodes. The node 41 is called a root node and the other nodes 42 to 45 are children of the node 41. Each edge is associated with an extracted letter. For example, a letter “B” is associated with the edge 41a.

Further, the leaf node of a branch of the syntax tree Th is associated with the ID of document data. If there are identical document data, their IDs are associated with a same leaf node.

Referring to FIG. 4, document data “data 1” and “data 2” have an identical character string and therefore their IDs “data #1” and “data #2” are associated with the node 45.

Referring back to FIG. 3, the duplicate data detector 131 detects document data (duplicate data) having an identical character string from the document data group on the basis of the created syntax tree. When such duplicate data are detected, the duplicate data detector 131 outputs the IDs of duplicate data other than one piece of duplicate data to the data remover 200.

The data remover 200 deletes the document data with the received IDs from the data memory 110. That is to say, data cleansing can be performed on the document data of the data memory 110.

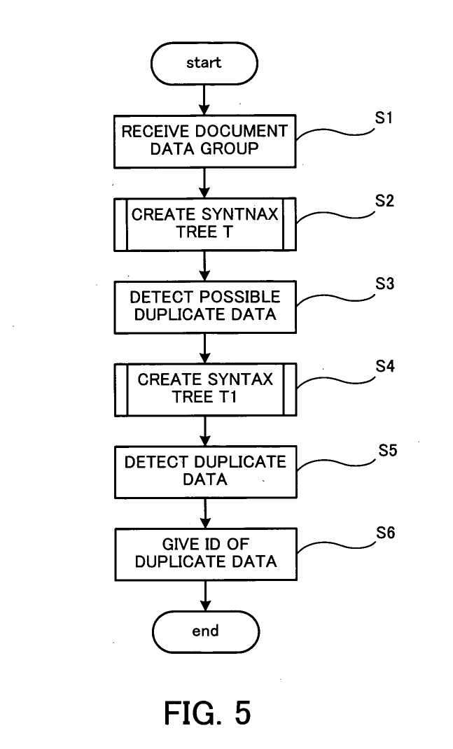

The analysis operation of the analyzer 130 will be described in detail with reference to the flowchart of FIG. 5.

At step S1, the duplicate data detector 131 receives a document data group. Then the duplicate data detector 131 gives the tree constructor 132 construction parameters (the first construction parameters) defining how many and which letters should be extracted. The construction parameters are stored in the HDD 103, for example.

It should be noted that the letter extraction positions specified by the first construction parameters are not limited, provided that the positions are not continuous. For example, (An+1)-th letter or A⁽ⁿ⁺¹⁾-th letter where A=1, 2, . . . , and n=0, 1, 2, . . . , can be applied. The latter case is useful for comparing two pieces of document data having almost identical character strings but different only in the last part. Alternatively, specific positions such as the first letter, the fourth letter, . . . can be set.

The number of letters to be extracted under the first construction parameters is not limited, provided that the number is one or greater integral number.

At step S2, the tree constructor 132 creates a syntax tree T under the first construction parameters. In this connection, if data is not long enough to extract a prescribed number of letters, the tree constructor 132 creates a syntax tree T based on only extracted letters.

Then the duplicate data detector 131 determines for every leaf node of the syntax tree T whether some pieces of data are associated with the leaf node. If yes, the data are detected as possible duplicate data at step S3.

Then, the duplicate data detector 131 gives the tree constructor 132 construction parameters (the second construction parameters) defining that all letters be extracted in order from the first letter with respect to each of the possible duplicate data.

At step S4, the tree constructor 132 creates a syntax tree T1 under the second construction parameters.

Then the duplicate data detector 131 searches each leaf node of the syntax tree T1 to find whether some pieces of data are associated with the leaf node. If yes, the data are detected as duplicate data at step S5.

At step S6, the duplicate data detector 131 outputs the IDs of the duplicate data to the data remover 200, and then the analysis operation is completed.

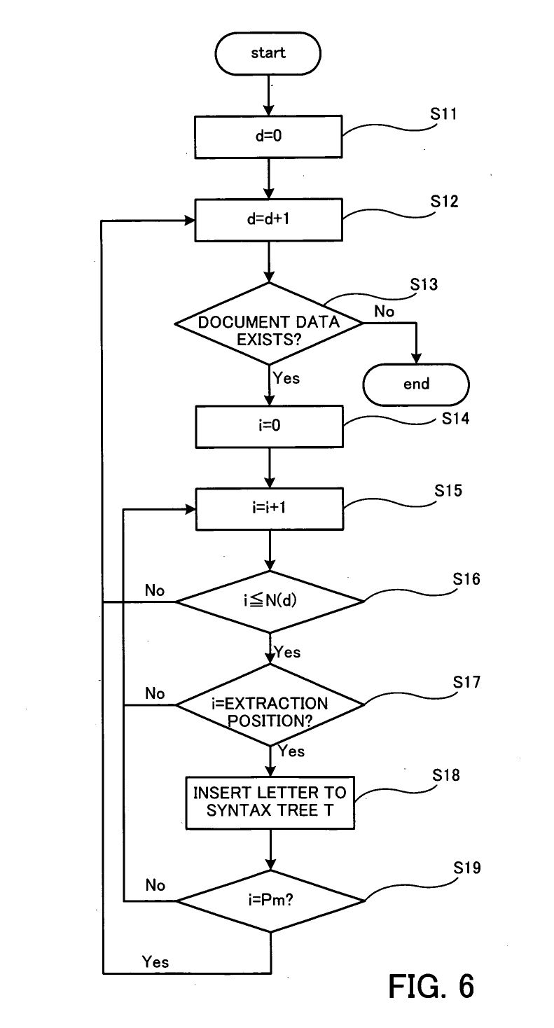

Next, the first tree construction operation of the tree constructor 132 to create a syntax tree T under the first construction parameters will be described with reference to the flowchart of FIG. 6.

For simple explanation, the following symbols are used:

Identifiers: d (d=0, 1, 2, . . . )

Position of present letter: i

The number of letters composing document data with identifier d: N(d)

Positions for extracting letters: P1, . . . , Pm

At step S11, an identifier d is initialized (d=0).

At step S12, the identifier d is incremented.

At step S13, it is determined whether there is document data with the identifier d. If not, meaning that there is no such data, this first tree construction operation is completed. If yes, on the contrary, a letter position i is initiated (i=0) at step S14.

At step S15, the letter position i is incremented.

At step S16, it is determined whether the letter position i is the number of letters N(d) or smaller. If not, meaning that the position i is greater than the number of letter N(d), this operation goes back to step S12 to continue the operation. If yes, on the contrary, it is determined at step S17 whether the letter position i matches any of the extraction positions P1, . . . , Pm. If not, meaning that the letter position is not an extraction position, this operation returns back to step S15 to continue the operation. If yes, on the contrary, the letter at the letter position i is inserted to the syntax tree T at step S18.

At step S19 it is determined whether the letter position i is the last extraction position Pm. If not, meaning that there are following letters, the operation goes back to step S15 to continue the operation. If yes, on the contrary, the operation goes back to step S12 to continue the operation.

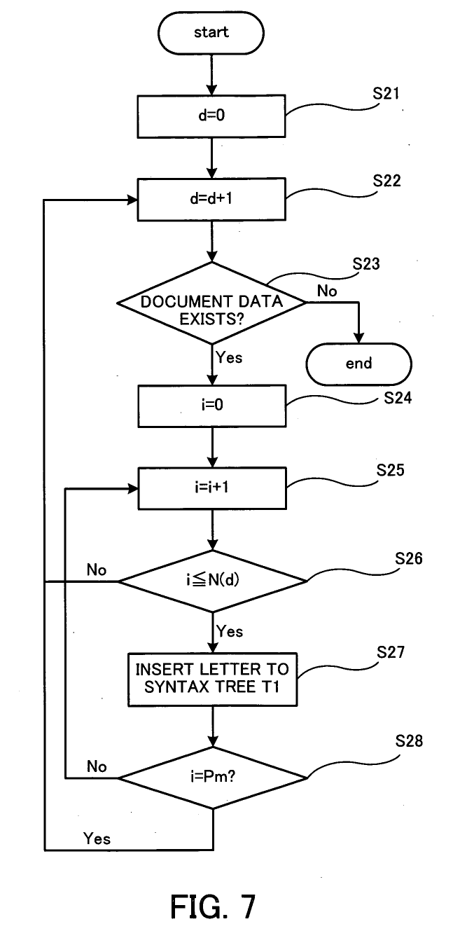

Next, the second tree construction operation of the tree constructor 132 to create a syntax tree T1 under the second construction parameters will be described with reference to the flowchart of FIG. 7.

At steps S21 to S26, the same operation as step S11 to S16 of the first tree construction operation is performed.

If determination at step S26 results in yes meaning that the letter position i is the number of letters N(d) or smaller, the letter at the letter position i is inserted to the syntax tree T1 at step S27.

At step S28, the same operation as step S19 of the first tree construction operation is performed.

The first and second tree construction operations will be now described in detail.

In this example, the first construction parameters define that four letters existing at (4n+1)-th positions should be extracted in order from the first letter. In addition, a document data group includes references 1 to 3.

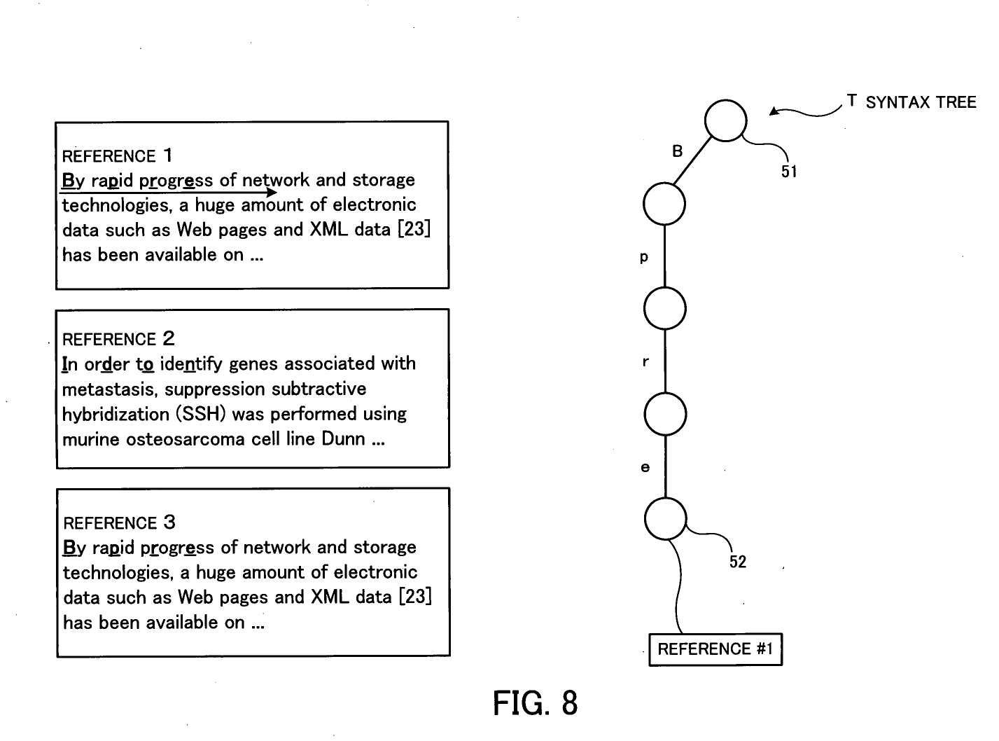

FIGS. 8 to 10 show the example of the first tree construction operation.

The tree constructor 132 extracts four letters existing at the (4n+1)-th positions from the reference 1 in order from the first letter under the first construction parameters, and creates a syntax tree T with a node 51 as a root node (refer to FIG. 8). In more detail, four letters: the first letter “B”, the fifth letter p the ninth letter “r”, and the thirteenth letter “e”, are extracted from the reference 1. In addition, the identifier “reference #1” of the reference 1 is associated with a leaf node 52.

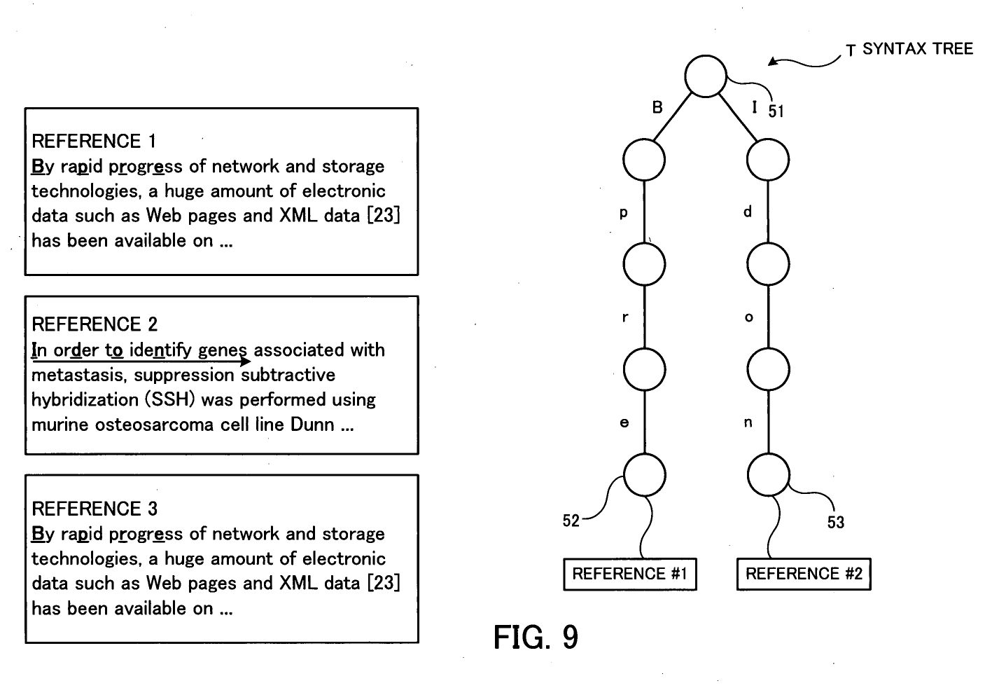

Then, the tree constructor 132 extracts four letters existing at the (4n+1)-th positions from the reference 2 in order from the first letter under the first construction parameters, and inserts them to the syntax tree T (refer to FIG. 9). In more detail, four letters: the first letter “I”, the fifth letter “d”, the ninth letter “o”, and the thirteenth letter “n” are extracted. In addition, the identifier “reference #2” of the reference 2 is associated with a leaf node 53.

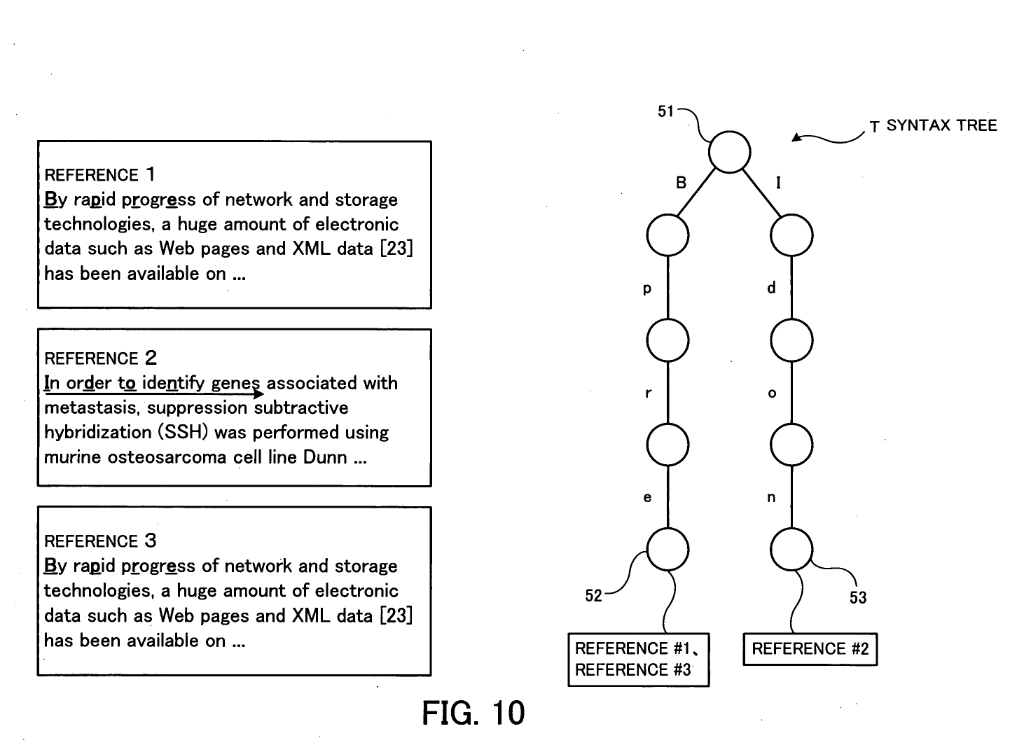

Then, the tree constructor 132 extracts four letters existing at the (4n+1)-th positions from the reference 3 in order from the first letter under the first construction parameters, and inserts them to the syntax tree T (refer to FIG. 10). Since the extracted letters form already created nodes, new nodes are not created and the identifier “reference #3” of the reference 3 is associated with the leaf node 52.

It can be confirmed from the created syntax tree T that the identifiers “reference #1” and “reference #3” are both associated with the same leaf node 52. Therefore, the references 1 and 3 are detected as possible duplicate data.

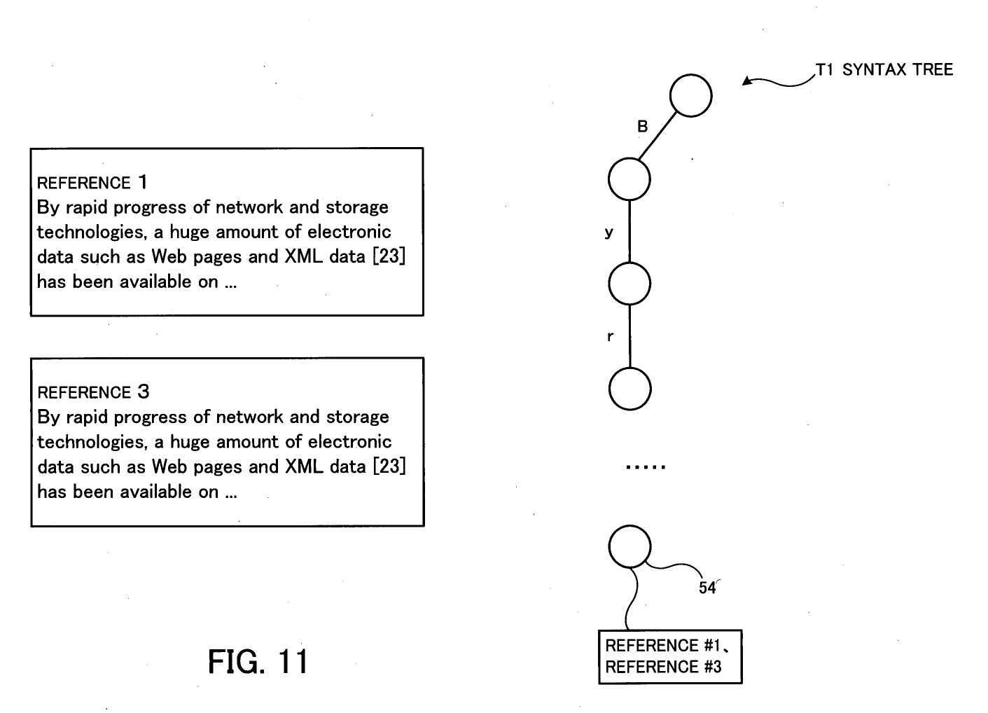

The second tree construction operation will be described in detail with reference to FIG. 11.

With respect to each of the references 1 and 3, the tree constructor 132 extracts all letters one by one in order from the first letter and inserts them to a syntax tree T1.

Referring to FIG. 11, the first letter “B”, the second letter “y”, the third letter “r”, . . . are sequentially inserted to the syntax tree T1. In a case where the identifiers “reference #1” and “reference #3” are both associated with the same leaf node 54 by inserting all letters, the reference 1 and the reference 3 are detected as duplicate data.

As described above, according to the computer 300 of this embodiment, the data detector 100 detects possible duplicate data by creating a syntax tree T, and then detects duplicate data by creating a syntax tree T1. The syntax tree T enables narrowing data down to possible duplicate data. Detection of possible duplicate data reduces the scale of the syntax tree T1, as compared with a case of creating a syntax tree from all letters of document data from the start. As a result, search efficiency is improved and thus duplicate data can be detected in a short time.

For example, for the abstracts of essays, a usable number of letters may be determined. Therefore, if a method of identifying duplicate document data in view of the number of letters is employed, a plurality of different data may be detected as possible duplicate data. Contrary to such a method, the data detector 100 of this embodiment can realize higher-reliable detection.

According to this embodiment, the duplicate data detector 131 outputs to the data remover 200 the IDs of duplicate data other than one piece of duplicate data out of detected duplicate data, and the data remover 200 deletes the document data with the IDs from the data memory 110. This invention is not limited thereto and the duplicate data detector 131 can output the IDs of all detected duplicate data to the data remover 200 which can then delete document data with the IDs other than a certain ID out of the received IDs, from the data memory -110. It is not especially determined which duplicate data should remain in the storage 110. For example, duplicate data with the smallest ID may be kept in the storage 110.

Further, according to this embodiment, the tree constructor 132 creates a syntax tree T, T1 by extracting letters from data in order from the first letter. This invention is not limited to this and the syntax tree T, T1 can be created by extracting letters from the data in order from the last letter.

Still further, according to this embodiment, duplicate document data is detected from a plurality of document data. This invention is not limited to this and can be applied to detecting duplicate character strings from one piece of document data containing a plurality of characters strings that are separated with tags. Such document data includes Extensible Markup Language (XML) data, HyperText Markup Language (HTML) data, and Comma Separated Values (CSV) data.

Still further, according to this embodiment, the document data with IDs detected as duplicate data by the duplicate data detector 131 is deleted by the data remover 200 from the data memory 110. However, the detected duplicate data can be processed in a different way.

Still further, the volume of document data to be applicable in this invention is not limited, but relatively large data, for example, XML data with one record of 100 to 10000 letters or more, is preferable. If relatively large data are detected as possible duplicate data, the possible duplicate data are more likely identified as duplicate data with the second tree construction operation, which realizes high-speed detection of duplicate data. This invention is very usable for detecting such duplicate data.

The usage of this invention is not especially limited, but is usable for data cleansing in a database, deleting spam mails, and data compression, for example. If this invention is applied in a mail server, spam mails can be deleted by detecting duplicate titles and text of electronic mails. Alternatively, if this invention is applied for a database, data is compressed by keeping one piece of duplicate data and deleting the other duplicate data, and then the remaining duplicate data is accessed instead of the other duplicate data. In a case where one piece of document data has a plurality of character strings, data can be reduced by keeping one duplicate character string and deleting the other duplicate character strings, and then the existing character string is referenced instead of the other character strings.

The processing functions described above can be realized by a general computer (by causing a computer to execute a prescribed duplicate data detection program). In this case, a program is prepared, which describes processes for the functions to be performed by the data detector 100. The program is executed by a computer, whereupon the aforementioned processing functions are accomplished by the computer. The program describing the required processes may be recorded on a computer-readable recording medium. Computer-readable recording media include magnetic recording devices, optical discs, magneto-optical recording media, semiconductor memories, etc. The magnetic recording devices include Hard Disk Drives (HDD), Flexible Disks (FD), magnetic tapes, etc. The optical discs include Digital Versatile Discs (DVD), DVD-Random Access Memories (DVD-RAM), Compact Disc Read-Only Memories (CD-ROM), CD-R (Recordable)/RW (ReWritable), etc. The magneto-optical recording media include Magneto-Optical disks (MO) etc.

To distribute the program, portable recording media, such as DVDs and CD-ROMs, on which the program is recorded may be put on sale. Alternatively, the program may be stored in the storage device of a server computer and may be transferred from the server computer to other computers through a network.

A computer which is to execute the duplicate data detection program stores in its storage device the program recorded on a portable recording medium or transferred from the server computer, for example. Then, the computer runs the program. The computer may run the program directly from the portable recording medium. Also, while receiving the program being transferred from the server computer, the computer may sequentially run this program.

According to this invention, possible duplicate data and then duplicate data can be easily detected. In addition, time for detecting the duplicate data can be reduced because a more detailed syntax tree is created based on already limited possible duplicate data.

The foregoing is considered as illustrative only of the principle of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A computer-readable recording medium containing a duplicate data detection program for detecting duplicate data out of a plurality of data each including a character string, the duplicate data detection program causing a computer to perform as:
syntax tree construction means for creating a syntax tree by extracting a plurality of letters existing at prescribed discrete positions from the character string of each of the plurality of data; and
duplicate data detection means for searching each leaf node of the syntax tree to find some of the plurality of data that have reached the leaf node, and detecting the some of the plurality of data as possible duplicate data.

2. The computer-readable recording medium according to claim 1, wherein:
the syntax tree construction means creates a detailed syntax tree by extracting all letters one by one from the character string of each of the possible duplicate data in order from the first or the last letter; and
the duplicate data detection means searches each leaf node of the detailed syntax tree to find some of the possible duplicate data that have reached the leaf node of the detailed syntax tree and detects the some of the possible duplicate data as duplicate data.

3. The computer-readable recording medium according to claim 1, wherein the syntax tree construction means creates the syntax tree by extracting a prescribed number of letters existing at the prescribed discrete positions.

4. A method for detecting duplicate data out of a plurality of data each having a character string, comprising the steps of:
creating a syntax tree by extracting a plurality of letters existing at prescribed discrete positions from the character string of each of the plurality of data;
searching each leaf node of the syntax tree to find some of the plurality of data that have reached the leaf node of the syntax tree; and
detecting the some of the plurality of data as possible duplicate data.

5. An apparatus for detecting duplicate data out of a plurality of data each having a character string, comprising:
syntax tree construction means for creating a syntax tree by extracting a plurality of letters existing at prescribed discrete positions from the character string of each of the plurality of data; and
duplicate data detection means for searching each leaf node of the syntax tree to find some of the plurality of data that have reached the leaf node of the syntax tree and detecting the some of the plurality of data as possible duplicate data.
